(19) United States
(12) Patent Application Publication
(10) Pub. No.: US 2024/0009573 A1
(43) Pub. Date: Jan. 11, 2024

(54) PROMPT METHOD AND APPARATUS FOR OBTAINING VIRTUAL REWARD RESOURCE, AND STORAGE MEDIUM

(71) Applicant: Tencent Technology (Shenzhen) Company Limited, Shenzhen (CN)

(72) Inventors: Chenxing PEI, Shenzhen (CN); Peiyuan ZENG, Shenzhen (CN); Welsong ZHANG, Shenzhen (CN)

(21) Appl. No.: 18/371,977

(22) Filed: Sep. 22, 2023

Related U.S. Application Data
(63) Continuation of application No. PCT/CN2022/129599, filed on Nov. 3, 2022.

(30) Foreign Application Priority Data
Dec. 13, 2021 (CN) 202111521238.5

(51) Int. Cl. A63F 13/69; A63F 13/79

(52) U.S. Cl. CPC A63F 13/69; A63F 13/79

(57) ABSTRACT

This application discloses a method for obtaining a virtual reward resource performed by an electronic device. The method includes: displaying a progress prompt window of a virtual reward resource matching a target user account in a battle mode selection interface of a game application, the progress prompt window comprising a current resource growth level and a resource obtaining status of the target user account; receiving a trigger operation performed on the progress prompt window; in response to the trigger operation on the progress prompt window, displaying a growth track of the virtual reward resource matching the target user account, the growth track comprising growth nodes respectively corresponding to different resource growth levels, each growth node prompting a virtual reward resource and a resource obtaining status that correspond to the resource growth level; and marking an account identifier of the target user account at a location corresponding to the current resource growth level on the growth track.

### CROSS-REFERENCE TO RELATED APPLICATIONS

This application is a continuation application of PCT Patent Application No. PCT/CN2022/129599, entitled “PROMPT METHOD AND APPARATUS FOR OBTAINING VIRTUAL REWARD RESOURCE, STORAGE MEDIUM, AND ELECTRONIC DEVICE” filed on Nov. 3, 2022, which claims priority to Chinese Patent Application No. 202111521238.5, entitled “PROMPT METHOD AND APPARATUS FOR OBTAINING VIRTUAL REWARD RESOURCE, STORAGE MEDIUM, AND ELECTRONIC DEVICE” filed with the National Intellectual Property Administration, PRC on Dec. 13, 2021, all of which is incorporated herein by reference in its entirety.

### FIELD OF THE TECHNOLOGY

This application relates to the field of computers, and specifically, to a prompt method and apparatus for obtaining a virtual reward resource, a storage medium, and an electronic device.

### BACKGROUND OF THE DISCLOSURE

Nowadays, in a multiplayer online battle arena (MOBA) application, players are often provided with a plurality of different game battle modes, such as a normal match mode in which the players are randomly matched to teammates and opponents, or a ranked mode in which the players are matched to teammates and opponents whose competitive dans match those of the players.

### SUMMARY

According to an embodiment of this application, a method for obtaining a virtual reward resource is performed by an electronic device and the method includes: displaying a progress prompt window of a virtual reward resource matching a target user account in a battle mode selection interface of a game application, the progress prompt window comprising a current resource growth level and a resource obtaining status of the target user account; receiving a trigger operation performed on the progress prompt window; in response to the trigger operation on the progress prompt window, displaying a growth track of the virtual reward resource matching the target user account, the growth track comprising growth nodes respectively corresponding to different resource growth levels, each growth node prompting a virtual reward resource and a resource obtaining status that correspond to the resource growth level; and marking an account identifier of the target user account at a location corresponding to the current resource growth level on the growth track.

According to an embodiment of this application, a non-transitory computer-readable storage medium is further provided, storing a computer program, the computer program being configured to, when executed by a processor of an electronic device, causes the electronic device to perform the foregoing method for obtaining a virtual reward resource.

According to an embodiment of this application, an electronic device is further provided, including a memory and a processor, the memory storing a computer program that, when executed by the processor, causes the electronic device to perform the foregoing method for obtaining a virtual reward resource through the computer program.

### BRIEF DESCRIPTION OF THE DRAWINGS

The accompanying drawings described herein are used to provide a further understanding of this application, and constitute a part of this application. Exemplary embodiments of this application and descriptions thereof are used to explain this application, and do not constitute any inappropriate limitation to this application. In the accompanying drawings:

FIG. 1 is a schematic diagram of a hardware environment of a method for obtaining a virtual reward resource according to an embodiment of this application.

FIG. 2 is a flowchart of a method for obtaining a virtual reward resource according to an embodiment of this application.

FIG. 3 is a schematic diagram of a method for obtaining a virtual reward resource according to an embodiment of this application.

FIG. 4 is a schematic diagram of another method for obtaining a virtual reward resource according to an embodiment of this application.

FIG. 5 is a schematic diagram of still another method for obtaining a virtual reward resource according to an embodiment of this application.

FIG. 6 is a schematic diagram of still another method for obtaining a virtual reward resource according to an embodiment of this application.

FIG. 7 is a schematic diagram of still another method for obtaining a virtual reward resource according to an embodiment of this application.

FIG. 8 is a flowchart of another method for obtaining a virtual reward resource according to an embodiment of this application.

FIG. 9 is a schematic structural diagram of an apparatus for obtaining a virtual reward resource according to an embodiment of this application.

FIG. 10 is a schematic structural diagram of an electronic device according to an embodiment of this application.

### DESCRIPTION OF EMBODIMENTS

To make a person skilled in the art better understand solutions of this application, the technical solutions in the embodiments of this application are clearly and completely described below with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

In the specification, claims, and the accompanying drawings of this application, the terms “first”, “second”, and so on are intended to distinguish between similar objects but do not necessarily indicate a specific order or sequence. It is to be understood that data used in this way is interchangeable in a suitable case, so that the embodiments of this application described herein can be implemented in an order other than those illustrated or described herein. Furthermore, the terms “include”, “have”, and any variants thereof are intended to cover non-exclusive inclusion. For example, a process, a method, a system, a product, or a device that includes a series of steps or units is not necessarily limited to those explicitly listed steps or units, but may include other steps or units not explicitly listed or inherent to the process, the method, the product, or the device.

Currently, in a related game application, only a gaming battle task-based win quantity is provided to provide a corresponding dan up reward for a player. However, difficulty in battling for the player in a ranked mode is great. Therefore, there is always a case in which the player gets stuck at a same dan for a long time and cannot be further improved. In this way, many players lose interest in continuing to use the game application, resulting in a loss of some users. That is to say, a problem of great difficulty in operation exists in a manner for obtaining a virtual reward resource provided in a related technology, causing a waste of device resources of a virtual reward resource system and low efficiency of man-machine interaction.

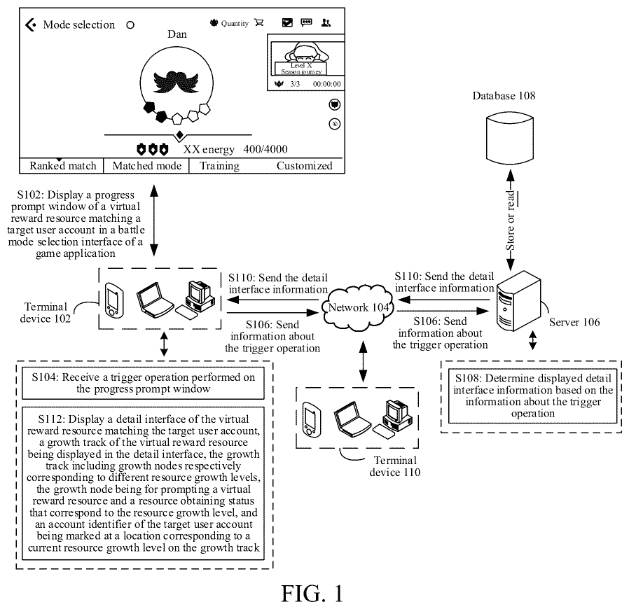

In view of this, an embodiment of this application provides a method for obtaining a virtual reward resource. In some embodiments, the method for obtaining a virtual reward resource may be applied to, but is not limited to, a system for obtaining a virtual reward resource in a hardware environment shown in FIG. 1. The system for obtaining a virtual reward resource may include, but is not limited to, a terminal device 102, a network 104, a server 106, a database 108, and a terminal device 110. Target clients (as shown in FIG. 1, an example in which a MOBA game application client is the target client is used) respectively run in the terminal device 102 and the terminal device 110. The terminal device 102 and the terminal device 110 each include a man-machine interaction screen, a processor, and a memory. The man-machine interaction screen is configured to display a virtual game scenario (a virtual game scenario shown in FIG. 1), and is further configured to provide a man-machine interaction interface to receive a man-machine interaction operation for controlling a controlled virtual object in a virtual scenario, where the virtual object is to complete a game task set in the virtual scenario. The processor is configured to generate an interaction instruction in response to the man-machine interaction operation, and send the interaction instruction to the server. The memory is configured to store related attribute data, for example, object attribute information of the controlled virtual object, and attribute information of a held virtual prop. The attribute information may include, but is not limited to, information for identifying an identity, a current location, and the like of the virtual object. A client that controls a first virtual object runs in the terminal device 102. In some embodiments, when a second virtual object is a virtual object controlled by a terminal device, a client that controls the second virtual object runs in the terminal device 110. The second virtual object and the first virtual object are in different camps.

In addition, the server 106 includes a processing engine, and the processing engine is configured to perform a storing or reading operation on the database 108. Specifically, the processing engine reads a location of each virtual object and information about an operation performed by each virtual object from the database 108.

A specific process is as follows. In step S102, a progress prompt window of a virtual reward resource matching a target user account is displayed in a battle mode selection interface of a game application. In step S104, a trigger operation performed on the progress prompt window is received in the client running in the terminal device 110. Then, step S106 is performed, and information about the trigger operation is sent to the server 106 through the network 104. The server 106 is to perform step S108: The server determines displayed detail interface information according to the information about the trigger operation. Then, in step S110, the server 106 sends the detail interface information to the terminal device 102 through the network 104. In step S112, a detail interface of the virtual reward resource matching the target user account is displayed on the terminal device 102, a growth track of the virtual reward resource being displayed in the detail interface, the growth track including growth nodes respectively corresponding to different resource growth levels, the growth node being for prompting a virtual reward resource and a resource obtaining status that correspond to the resource growth level, and an account identifier of the target user account being marked at a location corresponding to a current resource growth level on the growth track.

In some embodiments, when the terminal device 102 has a greater computing processing capability, step S108 may also be completed by the terminal device 102. The description herein is an example, and is not limited in this embodiment.

In some embodiments, the terminal device may be a terminal device provided with a target client and may include, but is not limited to, at least one of the following: a mobile phone (for example, an Android mobile phone or an iOS mobile phone), a notebook computer, a tablet computer, a palmtop computer, a mobile Internet device (MID), a PAD, a desktop computer, a smart television, and the like. The target client may be a client, such as a video client, an instant messaging client, a browser client, or an education client, that supports providing a shooting game task. The foregoing network may include, but is not limited to, a wired network and a wireless network. The wired network includes: a local area network, a metropolitan area network, and a wide area network. The wireless network includes: Bluetooth, Wi-Fi, and other networks that achieve wireless communication. The foregoing server may be a single server, a server cluster that includes a plurality of servers, or a cloud server. The foregoing description is merely an example, and is not limited in this embodiment.

In some embodiments, the method for obtaining a virtual reward resource may be applied to, but is not limited to, a game terminal application (APP) in which a predetermined confrontation game task is completed in a virtual scenario, for example, a virtual confrontation game application in a multiplayer online battle arena (MOBA) application. The confrontation game task may be, but is not limited to, a game task that is completed through confrontation interaction between a virtual object with which a current player performs man-machine interaction in a virtual scenario in which a virtual reward resource is obtained and a virtual object controlled by another player. The confrontation game task may be run, but is not limited to, in an application (for example, a non-stand-alone game APP) in a form of a plug-in and an applet, or in an application (for example, a stand-alone game APP) in a game engine. A type of the game application may include, but is not limited to, at least one of the following: a two dimensional (2D) game application, a three dimensional (3D) game application, a virtual reality (VR) game application, an augmented reality (AR) game application, and a mixed reality (MR) game application. The foregoing description is merely an example, and is not limited in this embodiment.

In this embodiment of this application, a progress prompt window of a virtual reward resource matching a target user account is displayed in a battle mode selection interface of a game application; a trigger operation performed on the progress prompt window is received; and a detail interface of the virtual reward resource matching the target user account is displayed, a growth track of the virtual reward resource being displayed in the detail interface, the growth track including growth nodes respectively corresponding to different resource growth levels, the growth node being for prompting a virtual reward resource and a resource obtaining status that correspond to the resource growth level, and an account identifier of the target user account being marked at a location corresponding to a current resource growth level on the growth track. In this way, by using a reward method of a virtual reward resource indicated based on the growth track, a manner for obtaining a virtual reward resource is more intuitively displayed, to resolve a technical problem of great difficulty in operation in the manner for obtaining the virtual reward resource in the related technology, thereby avoiding a waste of device resources of a virtual reward resource system and improving man-machine interaction efficiency.

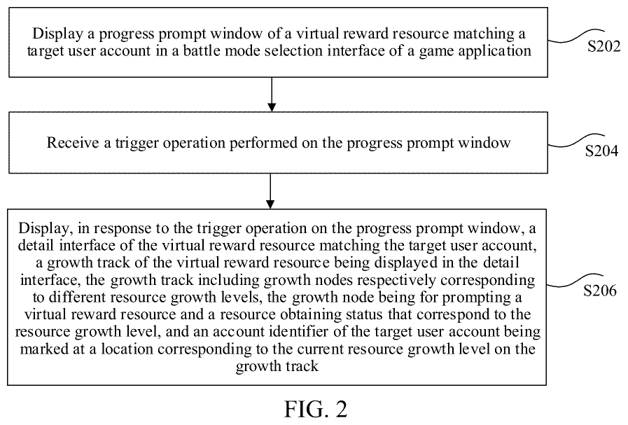

In some embodiments, as shown in FIG. 2, the method for obtaining a virtual reward resource includes the following steps:
S202: Display a progress prompt window of a virtual reward resource matching a target user account in a battle mode selection interface of a game application.

The progress prompt window includes a current resource growth level and a resource obtaining status that are of the target user account.
S204: Receive a trigger operation performed on the progress prompt window.
S206: Display, in response to the trigger operation on the progress prompt window, a detail interface of the virtual reward resource matching the target user account, a growth track of the virtual reward resource being displayed in the detail interface, the growth track including growth nodes respectively corresponding to different resource growth levels, the growth node being for prompting a virtual reward resource and a resource obtaining status that correspond to the resource growth level, and an account identifier of the target user account being marked at a location corresponding to the current resource growth level on the growth track.

In some embodiments, the foregoing method for obtaining a virtual reward resource may be applied to, but is not limited to, a virtual confrontation game application provided for a confrontation application. The confrontation application may include, but is not limited to, each game in which a virtual weapon is used to perform a confrontation attack and that includes, but is not limited to, a first person confrontation application, a third person confrontation application, and the like. The first person confrontation application is a branch of an action application (ACT). As the name implies, the first person confrontation application is a confrontation application in which a confrontation is performed from a subjective perspective of an operator (player). The third person confrontation application is also one of the action application, and differs from the first person confrontation application in that a virtual controlled object controlled by an operator (player) is directly displayed in an observation visual field picture.

A battle mode is explained below. The battle mode selection interface is a game mode selection interface of a MOBA game. The battle mode may include, but is not limited to, game modes such as a “single-player mode”, a “multi-player mode”, an “arena mode”, and a “leisure mode”. For different game modes, a user account may obtain different game rewards. For example, game difficulty is high in the “area mode”, so that richer game rewards may be obtained, while game difficulty is low in the “leisure mode”, so that less content of game rewards may be obtained. It is to be understood that, in the “arena mode”, a basic principle for obtaining a game virtual reward resource is that a bonus point reward may be obtained when a victory in a game, and an original bonus point may be deducted when a defeat in a game, thereby obtaining a game reward according to accumulation of values of such bonus points. In other words, in the “arena mode”, obtaining of a game resource reward is related to only the victory or defeat of the game, and a player with a lower gaming level has difficulty in obtaining the victory in the game, resulting in having difficulty in obtaining a corresponding virtual reward resource. In other words, in the “arena mode”, a manner for obtaining a virtual reward resource is not friendly for the player with the lower gaming level, and difficulty in obtaining the virtual reward resource is great.

Further, in this embodiment of this application, a new method for obtaining a reward resource is provided. Corresponding to the method, the detail interface of the virtual reward resource matching the target user account may be displayed by triggering the progress prompt window in the battle mode selection interface of the game application. That is to say, the method in this embodiment differs from a resource reward method corresponding to a battle mode, directly provides a display entrance to the detail interface of the virtual reward resource in the battle mode selection interface, and directly displays resource reward-related parameter information in the entrance.

It is to be understood that, in the progress prompt window, the current resource growth level and the resource obtaining status that are of the target user account are also displayed. It may be understood that, the resource growth level in a resource reward system indicates a reward stage at which the target user account is located, the resource obtaining status may indicate status information of a reward resource corresponding to the target user account, for example, a taking status such as “taken” or “untaken”, and a quantity status of the reward resource. A specific representation form of the resource growth level and specific information included in the resource obtaining status are not limited herein.

Further, the trigger operation may be, but is not limited to, a touch control operation such as a click/tap operation, a slide operation, a long-press operation, or a double-click/tap operation performed on a terminal display interface. In some embodiments, when a click/tap operation performed on the progress prompt window is received, information about the trigger operation performed on the progress prompt window is deemed to be received.

Further, in response to the trigger operation performed on the progress prompt window, the detail interface of the virtual reward resource matching the target user account is displayed. What is displayed in the detail interface includes, but is not limited to, a growth track, and the growth track indicates status information and obtained resource reward information that are of the user account in the resource reward system. Specifically, growth nodes respectively corresponding to different resource growth levels are displayed on the growth track, and an account identifier of the user account is marked on the growth track to specifically indicate location information corresponding to the user account on the growth track.

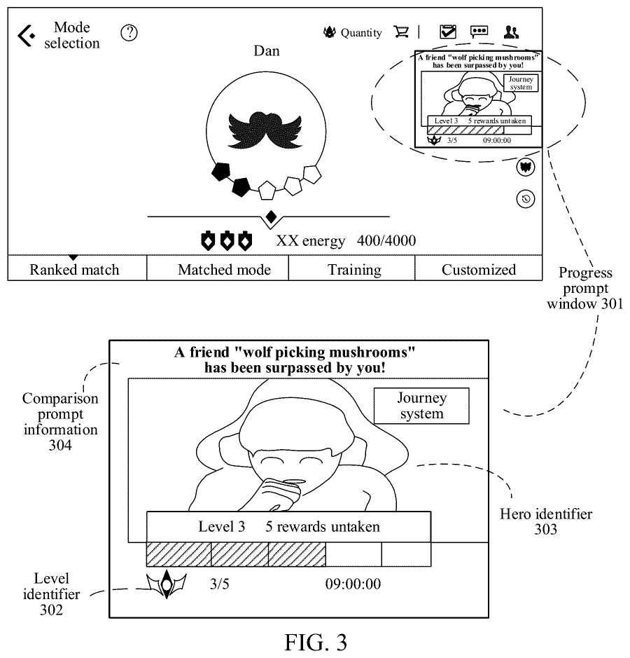

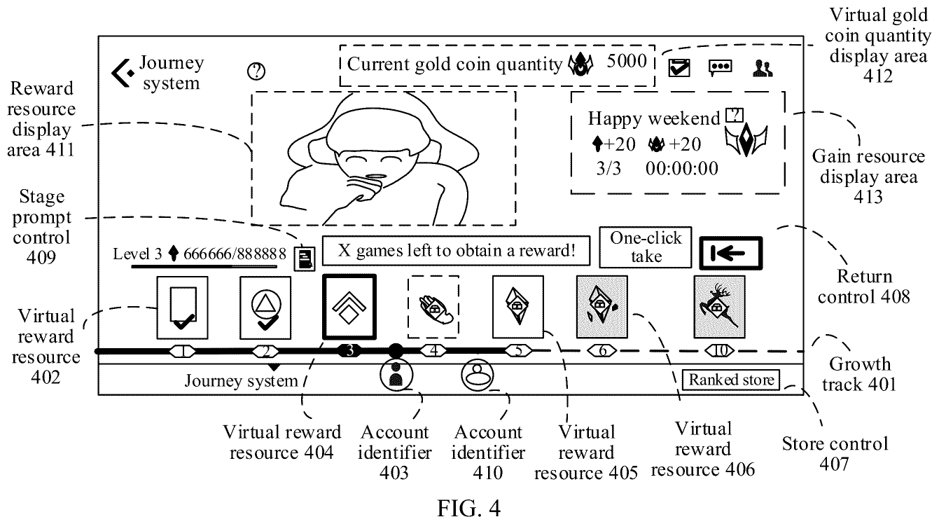

The method is specifically described below with reference to FIG. 3 and FIG. 4. As shown in FIG. 3, a specific battle mode selection interface of a confrontation game is displayed. As shown in the figure, a “mode selection” control is displayed on an upper left part of the interface for the user account to select different confrontation game modes. A progress prompt window 301 and an enlarged view of the progress prompt window 301 are further displayed in the battle mode selection interface. As shown in the figure, a current resource growth level “level 3” and a resource obtaining status “5 rewards untaken” are displayed in the progress prompt window. That is to say, in this embodiment, the progress prompt window is displayed in the battle mode selection interface, to intuitively display the current resource growth level and the resource obtaining status that are of the target user account and provide an entrance to the detail interface of the reward resource.

When a click/tap operation performed on the progress prompt window 301 is received, a trigger operation performed on the progress prompt window is deemed to be received. Further, the detail interface of the virtual reward resource as shown in FIG. 4 is displayed. First, each area displayed in FIG. 4 is generally introduced. As shown in FIG. 4, a reward resource display area 411, a virtual gold coin quantity display area 412, and a gain resource display area 413 are displayed on an upper part of the interface, and a growth track 401 and a related area are displayed on a lower part of the interface. The reward resource display area 411 is for specifically displaying an icon of a reward resource on the growth track 401. The virtual gold coin quantity display area 412 is for displaying a quantity of virtual gold coins obtained by a current user account. The virtual gold coin may be for exchanging resources in a ranked store. The gain resource display area 413 is for displaying gain bonuses of some auxiliary items set for different types of players. These gains help the player to complete a season journey faster, and improve initiative of the player in participation. One growth track 401 and a plurality of growth nodes displayed on the growth track 401 are displayed in a growth track area. As shown in FIG. 4, a virtual reward resource 402 corresponds to a growth node 1, and an image of a “√” shape is simultaneously displayed in the virtual reward resource 402, indicating that the reward resource corresponding to the growth node 1 has been taken. In addition, a progress node identifier corresponding to an account identifier 403 is also displayed on the growth track 401, indicating a location and progress information of a user account that corresponds to the account identifier 403 and that is in the growth track shown in the figure. A reward resource corresponding to a growth node 3 simultaneously displayed on the growth track 401 is displayed in bold, indicating that the current user account is in a growth level 3, and a corresponding reward resource is not displayed with the image of the “Ai” shape, indicating that the reward resource corresponding to the growth node 3 is still not taken by the current user account.

In this embodiment provided in this application, a progress prompt window of a virtual reward resource matching a target user account is displayed in a battle mode selection interface of a game application; a trigger operation performed on the progress prompt window is received; and a detail interface of the virtual reward resource matching the target user account is displayed. In this way, by using a reward method of a virtual reward resource indicated based on the growth track, a manner for obtaining a virtual reward resource is more intuitively displayed, to resolve a technical problem of great difficulty in operation in the manner for obtaining the virtual reward resource in the related technology, thereby avoiding a waste of device resources of a virtual reward resource system and improving man-machine interaction efficiency.

In some embodiments, that a progress prompt window of a virtual reward resource matching a target user account is displayed includes the following steps:
S1: Display a level identifier of the current resource growth level corresponding to the target user account in a current battle period in the progress prompt window.
S2: Display information about a countdown of the target user account to a resource growth stage next to a current resource growth stage in the progress prompt window, where one resource growth stage corresponds to a plurality of resource growth levels.

The current battle period may be understood as a period of time set in an application game. Parameters such as reward resources and growth indexes that are obtained by the user account in the period of time may be accumulated, and parameters such as reward resources and growth indexes that are obtained in a previous battle period are to be reset each time after a battle period is passed. For example, a battle period is set to be 6 months, and indicators such as record points, growth points, growth tracks of all game users that battle in the game application are to be accumulated. After the battle period of 6 months is passed, the indicators such as the record points, the growth points, and the growth tracks are to be reset, to motivate the users to continue to start a game battle of a new period.

Further, when the resource growth stage may appear as a sub-period of the battle period and, for example, the battle period is set to be 6 months, the resource growth stage may be set to be 1 month. Corresponding to the one-month resource growth stage, that there are 3 resource growth levels in the growth stage may be set, and each resource growth level has a corresponding reward resource. A next resource growth stage may be unlocked each time after a resource growth stage is passed, that is, more resource growth level space and more corresponding reward resources are provided for the user account. It is to be understood that, a reward resource obtained in each resource growth stage may not be reset according to switching of the resource growth stage.

That is to say, in this embodiment, a battle period which may cause resource reset is set, to motivate a user account with a lower game level to actively participate in a game battle as much as possible at the beginning of each battle period, to obtain more game resources in a new battle period. In addition, a plurality of resource growth stages are set, to motivate the user to frequently participate in the game battle through a reward of a shorter period.

The following provides further description with reference to FIG. 3. As shown in FIG. 3, a level identifier 302 and level identifier information “⅗” are displayed in the progress prompt window 301, indicating that in the current resource growth stage, an upper limit of the resource growth level is level 5, while a level of the current user account in the current resource growth stage is level 3. In addition, information “09:00:00” about the countdown of the target user account to the resource growth stage next to the current resource growth stage in the progress prompt window is further displayed on a right side of information of the level identifier 302 and the resource growth level, indicating that there are 9 hours left before the next resource growth stage. In this way, the user is motivated to actively participate in the game battle in the remaining 9 hours to obtain a higher resource growth level and obtain more reward resources.

In the foregoing embodiment of this application, a level identifier of the current resource growth level corresponding to the target user account in a current battle period is displayed in the progress prompt window; and information about a countdown of the target user account to a resource growth stage next to a current resource growth stage is displayed in the progress prompt window. In this way, a current resource growth status of the target user account can be more intuitively displayed, and the target user account is motivated to actively participate in a game battle in the remaining time to obtain more reward resources, to implement improving participation of the user in the game battle through an intuitive incentive of reward resources, thereby improving man-machine interaction efficiency.

In some embodiments, that a progress prompt window of a virtual reward resource matching a target user account is displayed includes: displaying resource obtaining prompt information in the progress prompt window, where the resource obtaining prompt information is for prompting a resource identifier of a current to-be-obtained target virtual reward resource of the target user account, the target virtual reward resource includes: a virtual reward resource of a dan reward type, a virtual reward resource of a key prop type, and a virtual reward resource of a basic prop type, a prompt priority of the virtual reward resource of the dan reward type is higher than a prompt priority of the virtual reward resource of the key prop type, and the prompt priority of the virtual reward resource of the key prop type is higher than a prompt priority of the virtual reward resource of the basic prop type.

The following explains the target virtual reward resource. It is to be understood that, the virtual reward resource of the dan reward type indicates a reward resource that may be obtained by the user account each time when a resource growth level is reached. In some embodiments, the virtual reward resource of the dan reward type may be a virtual gold coin. That is to say, in this embodiment of this application, each time the user account reaches a resource growth level, a virtual gold coin reward corresponding to the growth level may be obtained. In addition, the virtual reward resource of the key prop type may indicate a reward resource corresponding to a specified resource growth level, for example, reward resources that appear only at resource growth levels “5, 10, 15, . . . ”. In some embodiments, the virtual reward resource of the key prop type may be, to be specific, a special virtual hero object, and a user object may use or control the virtual hero object to participate in a confrontation game. In addition, the virtual reward resource of the basic prop type may be a reward resource corresponding to an unspecified resource growth level, for example, randomly corresponding to resource growth levels such as resource growth levels “2, 7, 9, 13, . . . ”. It may be understood that, a resource growth level quantity corresponding to the virtual reward resource of the basic prop type may be greater than a resource growth level quantity corresponding to the virtual reward resource of the key prop type, and some normal prop rewards, for example, a virtual accessory prop and a virtual skin prop, are simultaneously provided for decorating a virtual hero object that has been owned by a user object. In some embodiments, 100 virtual gold coin rewards may be provided corresponding to resource growth levels 1 to 10 each; corresponding to a resource growth level 5 and a resource growth level 10, a “hero A” and a “hero B” may be additionally provided as virtual reward resources on the basis of the virtual reward resource of the dan reward type; and corresponding to resource growth levels 2, 7, and 9, different skin rewards may be additionally provided on the basis of the virtual reward resource of the dan reward type.

It may be understood that, since a display area in the progress prompt window has a priority, a priority is set for displayed resource obtaining prompt information to display a most attractive reward resource in the progress prompt window to motivate the user to click/tap on the progress prompt window to participate in a resource reward activity. In some embodiments, a prompt priority of the virtual reward resource of the dan reward type is higher than a prompt priority of the virtual reward resource of the key prop type, and the prompt priority of the virtual reward resource of the key prop type is higher than a prompt priority of the virtual reward resource of the basic prop type. It may be understood that, in this embodiment, the virtual reward resource of the dan reward type may be accumulated to be further exchanged for another virtual prop, which may provide the user with enough freedom to select a virtual prop for which the user intends to exchange. However, a quantity of the virtual reward resources of the key prop type are limited and cannot be adjusted according to a requirement of the user. Therefore, the virtual reward resource of the key prop type is less attractive for the user than the virtual reward resource of the dan reward type. In addition, reward attractiveness of the virtual reward resource of the basic prop type is also lower than that of the virtual reward resource of the key prop type. Therefore, the prompt priorities of the three different reward resources are in descending order.

The method is specifically described below with reference to FIG. 3. The progress prompt window displayed in FIG. 3 is used as an example. Resource obtaining prompt information “5 rewards untaken” and a hero identifier 303 are displayed, indicating that the current user account still has a part of reward resources that are not taken, and in addition, a virtual hero reward corresponding to the hero identifier 303 may be obtained when a next resource growth level is reached.

In the foregoing embodiment of this application, resource obtaining prompt information is displayed in the progress prompt window, where the resource obtaining prompt information is for prompting a resource identifier of a current to-be-obtained target virtual reward resource of the target user account, the target virtual reward resource includes: a virtual reward resource of a dan reward type, a virtual reward resource of a key prop type, and a virtual reward resource of a basic prop type, a prompt priority of the virtual reward resource of the dan reward type is higher than a prompt priority of the virtual reward resource of the key prop type, and the prompt priority of the virtual reward resource of the key prop type is higher than a prompt priority of the virtual reward resource of the basic prop type. In this way, a manner for obtaining a virtual reward resource is more intuitively displayed, to resolve a technical problem of great difficulty in operation in the manner for obtaining the virtual reward resource in the related technology, thereby avoiding a waste of device resources of a virtual reward resource system and improving man-machine interaction efficiency.

In some embodiments, prompting, that resource obtaining prompt information is displayed in the progress prompt window includes: prompting, when a quantity of target virtual reward resources is greater than 1, a resource quantity of target virtual reward resources that are not taken in the progress prompt window; and/or displaying the resource obtaining prompt information in the progress prompt window according to a prompt priority of the target virtual reward resource.

It may be understood that, in this embodiment, when the quantity of target virtual reward resources is not greater than 1, an obtaining status of the reward resource may be directly displayed in the progress prompt window, for example, an icon of a to-be-taken reward resource may be highlighted. In another manner, when the quantity of the target virtual reward resource is greater than 1, it may be understood that, because a display area of the progress prompt window is limited, on the basis of displaying information about the icon of the to-be-taken reward resource in the progress prompt window, the resource quantity of the target virtual reward resources that are not taken is prompted in the progress prompt window in a text form, thereby more accurately and intuitively prompting information about the to-be-taken reward resource of the user account.

The interface shown in FIG. 3 is continued to be used as an example. When the quantity of the target virtual reward resource is not greater than 1, the icon of the to-be-taken reward resource or another related information may be directly highlighted in an area in which the hero identifier 303 is located. That is, as shown in FIG. 3, the hero identifier 303 corresponding to the reward resource is highlighted. In another manner, when the quantity of the target virtual reward resource is not greater than 1, because the display area of the progress prompt window is limited, the icon of the to-be-taken reward resource or another related information may be directly highlighted in the area in which the hero identifier 303 is located, and information “5 rewards untaken” of the to-be-taken reward resource is simultaneously identified around the identifier in a text form.

In the foregoing embodiment of this application, that resource obtaining prompt information is displayed in the progress prompt window includes: prompting, when a quantity of target virtual reward resources is greater than 1, a resource quantity of target virtual reward resources that are not taken in the progress prompt window. In this way, a manner for obtaining a virtual reward resource is more intuitively displayed, to resolve a technical problem of great difficulty in operation in the manner for obtaining the virtual reward resource in the related technology, thereby improving man-machine interaction efficiency.

In some embodiments, that a progress prompt window of a virtual reward resource matching a target user account is displayed includes: displaying comparison prompt information in the progress prompt window when the current resource growth level of the target user account is higher than a resource growth level of an associated user account, where the comparison prompt information is for prompting that the target user account has surpassed the associated user account.

The associated account may indicate an account that is associated with the target user account, namely, an account that has a special relationship with the target user account. For example, the account may have a friend relationship with the target user account, or may be an account followed by the target user account, or may be a blacklist account of the target user account. A specific type of the associated account is not limited herein.

It may be understood that, prompt information related to a resource growth status of the associated account of the target user account may be displayed in the progress prompt window, to improve a social attribute of a resource growth reward system. In some embodiments, only when the resource growth level of the target user account surpasses that of an associated account, related prompt information is displayed in the progress prompt window, indicating that the resource growth level of the target user account surpasses that of the associated account. It may be understood that, when a plurality of user accounts are surpassed, an associated account that is prompted in the comparison prompt information is a lately surpassed associated account.

In some embodiments, the comparison prompt information may be directly displayed and prompted in a text form, for example, “So-and-so has been surpassed by you!”. In another manner, the prompt information may be a comparison reminder in a form of a combination of an image and text, for example, may be a comparison reminder in a form of “account portrait”+“has been surpassed by you!”. It is easy to understand that, the account portrait is an account portrait of the associated account whose resource growth level has been surpassed by the resource growth level of the current user account, thereby improving intuitiveness of the comparison reminder.

The method is continued to be described with reference to FIG. 3. As shown in FIG. 3, comparison prompt information 304 “Friend ‘wolf picking mushrooms’ has been surpassed by you” is further displayed in the displayed progress prompt window, to prompt a resource growth status of a friend of the target user player.

In some embodiments, when the resource growth level of the target user has surpassed those of a plurality of associated accounts, account information of the plurality of surpassed associated accounts may be displayed in a scrolling display manner.

In some embodiments, when the current target user account does not surpass any associated account, comparison prompt information may be displayed to prompt an associated account that the user account may surpass next, for example, “So-and-so is about to be surpassed by you! Come on!”, thereby improving enthusiasm of a novice user to participate in the resource growth system.

In the foregoing embodiment of this application, that a progress prompt window of a virtual reward resource matching a target user account is displayed includes: displaying comparison prompt information in the progress prompt window when the current resource growth level of the target user account is higher than a resource growth level of an associated user account. In this way, a manner for obtaining a virtual reward resource is more intuitively displayed and a social attribute in the resource reward method is improved, to improve enthusiasm of the user in obtaining the virtual reward resource.

In some embodiments, that a detail interface of the virtual reward resource matching the target user account is displayed includes the following steps:
S1: Display the growth track of the virtual reward resource in the detail interface, where a corresponding resource prompt icon is displayed at each growth node of the growth track, a resource prompt icon corresponding to a growth node at which a virtual reward resource has been obtained is a resource identifier of the obtained virtual reward resource, and a resource prompt icon corresponding to a growth node at which a virtual reward resource has not been obtained is a locked identifier.
S2: Display a quantity of exchanged resources currently held by the target user account in the detail interface, where the exchanged resource is a reward resource obtained based on the growth track.

It is to be understood that, the virtual reward resource may include, but is not limited to, a virtual hero reward, a virtual skin reward, a virtual rare prop reward, and the like that are particularly provided in the current battle period.

The method is specifically described below with reference to FIG. 4. As shown in FIG. 4, the growth track 401 is displayed, and the growth track 401 is displayed in two forms. In this implementation, the growth track 401 including nodes 1 to 5 is displayed in a solid line form, and the growth track 401 after a growth node 5 is displayed in a dotted line form. The growth track displayed by a solid line indicates a growth node and a reward resource that can be accumulated in the current resource growth stage; and the growth track displayed by a dotted line indicates a growth node and a reward resource that can be accumulated in the next resource growth stage.

A growth node corresponding to each growth level, and a virtual reward resource corresponding to each growth node are displayed on the growth track 401. As shown in the figure, a growth level of the target user account is level 3. Reward resources at the node 1 and the node 2 have been taken, and a reward resource corresponding to the node 3 is allowed to be taken but the user account does not take the reward resource. In addition, resource prompt icons corresponding to the nodes 1 to 3 each is displayed as a resource identifier of an obtained virtual reward resource. Because a current growth level of the target user account is level 3, resource prompt icons corresponding to growth nodes 4 to 10 that are displayed after the level 3 on the growth track 401 are locked identifiers, indicating that the nodes are to be activated and corresponding reward resources cannot be obtained.

In addition, on an upper right part of the interface shown in FIG. 4, the virtual gold coin quantity display area 412 is displayed, and a quantity of virtual gold coins held by the current user is “5000”. In this embodiment, every time the user account reaches a growth level, the user account is allowed to take a certain quantity of virtual gold coins as a level reward. The gold coin herein is a total quantity of gold coins obtained by the user account in a growth reward interface. It may be understood that, after obtaining the virtual gold coins, the user may enter a “ranked store” through a touch control operation on a store control 407, so that the virtual gold coins may be used to exchange a virtual prop, a virtual skin, or a virtual hero that the user account intends to obtain.

In the foregoing embodiment of this application, the growth track of the virtual reward resource is displayed in the detail interface; and a quantity of exchanged resources currently held by the target user account are displayed in the detail interface. In this way, a manner for obtaining a virtual reward resource is more intuitively displayed, to resolve a technical problem of great difficulty in operation in the manner for obtaining the virtual reward resource in the related technology.

In some embodiments, that the growth track of the virtual reward resource is displayed in the detail interface includes the following steps:
S1: Adjust a first growth node sequence in the currently displayed growth track to a second growth node sequence corresponding to a sliding progress of a slide operation in response to the slide operation on the growth track.
S2: Restore the second growth node sequence in the currently displayed growth track, in response to a click/tap operation performed on a return control in the detail interface, to a third growth node sequence that includes a growth node corresponding to the current resource growth level.

It is to be understood that, in this embodiment, the growth track may be controlled to display each node on the growth track according to the slide operation. For example, when detecting a slide operation indicating a backward sliding of the growth track, subsequent growth nodes of the growth track and corresponding reward resource icons may be previewed and displayed; and when detecting a slide operation indicating a forward sliding of the growth track, reward resources that have been obtained or taken may be reviewed and displayed.

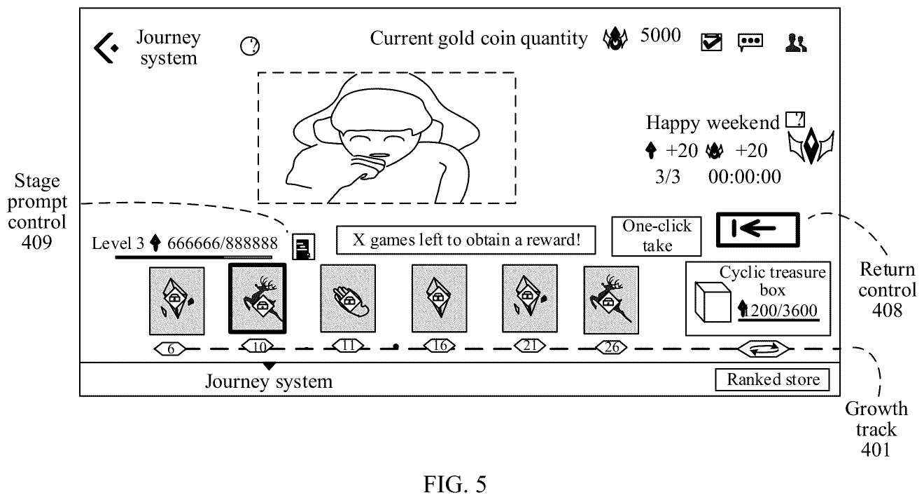

The foregoing method is specifically described with reference to FIG. 4 and FIG. 5. As shown in FIG. 4, a touch control operation is allowed to be performed on the growth track 401 to adjust the displayed growth node sequence. For example, in some embodiments, a node sequence displayed by default is nodes 1 to 10, that is, the foregoing nodes and reward resource icons corresponding to the foregoing nodes are displayed on the growth track 401. After detecting the slide operation performed on the growth track, as shown in FIG. 5, the node sequence displayed on the growth track is adjusted. In FIG. 5, the displayed growth node sequence is nodes 6 to 26. Further, when detecting a touch control operation on a return control 408 in FIG. 5, the interface shown in FIG. 4 is displayed, and the node sequence displayed by default is returned to. That is to say, in this embodiment, through a drag operation on the growth track, an unactivated growth node and a corresponding reward resource icon may be previewed and displayed, or reward resources that have been received may be reviewed and displayed. Through a touch control operation on a return control, one-click return to display a default growth node sequence may be implemented.

In some embodiments, in the node sequence displayed by default, a growth node corresponding to a current growth level of the user account is displayed in a center. For example, when the current growth level of the user account is level 7, and a once-displayed growth node sequence includes 9 nodes, the node sequence displayed by default is “3, 4, 5, 6, 7, 8, 9, 10, 11”. In another manner, a growth node corresponding to a current growth level of the user account may be displayed at a first location. For example, when the current growth level of the user account is level 7, and a once-displayed growth node sequence includes 9 nodes, the node sequence displayed by default is “7, 8, 9, 10, 11, 12, 13, 14, 15”.

In the foregoing embodiment of this application, a first growth node sequence in the currently displayed growth track is adjusted to a second growth node sequence corresponding to a sliding progress of a slide operation in response to the slide operation on the growth track; and the second growth node sequence in the currently displayed growth track is restored, in response to a click/tap operation performed on a return control in the detail interface, to a third growth node sequence that includes a growth node corresponding to the current resource growth level. In this way, the growth node is conveniently displayed on the growth track, so that a manner for obtaining a virtual reward resource is more intuitively displayed, to resolve a technical problem of great difficulty in operation in the manner for obtaining the virtual reward resource in the related technology.

In some embodiments, that a detail interface of the virtual reward resource matching the target user account is displayed includes: displaying, in response to an operation performed on a stage prompt control in the detail interface, resource attribute information of virtual reward resources respectively included in different resource growth stages on the growth track, where resource obtaining start time corresponding to the different resource growth stages is different.

It is to be understood that, in this embodiment, when the resource growth stage may appear as a sub-period of the battle period and, for example, the battle period is set to be 6 months, the resource growth stage may be set to be 1 month. Corresponding to the one-month resource growth stage, that there are 3 resource growth levels in the resource growth stage may be set, and each resource growth level has a corresponding reward resource. A next resource growth stage may be unlocked each time after a resource growth stage (which may also be referred to as a stage) is passed, that is, more resource growth level space and more corresponding reward resources are provided for the user account.

As shown in FIG. 4 and FIG. 5, a current resource growth node and each growth node of subsequent resource growth stage are displayed on the growth track 401, and different resource growth stages are differentiated in a manner of displaying a reward resource corresponding to the growth node. As shown in FIG. 4, a reward resource corresponding to a growth node of a current stage are highlighted on the growth track 401. Nodes 1 to 3 has been activated, reward resources corresponding to the node 1 and the node 2 has been taken, and a reward resource corresponding to the node 3 is not taken. In addition, because a growth level of the current user account is insufficient, reward resources corresponding to a node 4 and a node 5 cannot be taken. In a next resource growth stage, reward resource icons corresponding to nodes 6 to 10 are displayed in grayscale, indicating that the resource growth stage is not started and a reward resource corresponding to the resource growth stage cannot be obtained. As shown in FIG. 5, all nodes on the growth track 401 correspond to subsequent resource growth stages, so that icons of corresponding reward resources are displayed in grayscale.

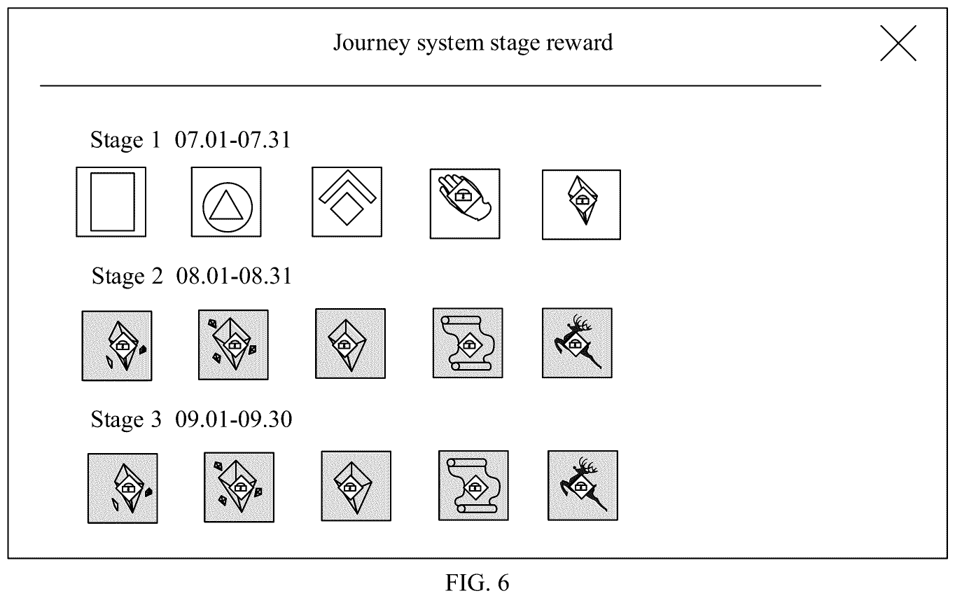

It may be understood that, a display area on the growth track has a priority. Therefore, this embodiment further provides a method for displaying a reward resource in detail. As shown in FIG. 4, a stage prompt control 409 is displayed at a lower left part. In a case of detecting a touch control on the control, a “Journey system stage reward” interface shown in FIG. 6 is displayed. In the interface, attribute information of reward resources that may be obtained in different resource growth stages is displayed in detail. An icon of a reward resource that may be obtained in a subsequent resource growth stage is displayed in grayscale, an icon of a reward resource that may be obtained in a current resource growth stage is highlighted, and an icon corresponding to a reward resource that is not allowed to be taken temporarily is locked. It may be understood that, in the interface, another related attribute information of the reward resource may also be further displayed, which may be but is not limited to that attribute information such as a preview effect, a price attribute, and a gain effect attribute of the reward resource of the reward resource is displayed. Content displayed in detail in the interface is not limited herein.

In the foregoing embodiment of this application, a detail interface of the virtual reward resource matching the target user account is displayed; and in response to an operation performed on a stage prompt control in the detail interface, resource attribute information of virtual reward resources respectively included in different resource growth stages on the growth track. In this way, a manner for obtaining a virtual reward resource is more intuitively displayed, to resolve a technical problem of great difficulty in operation in the manner for obtaining the virtual reward resource in the related technology.

In some embodiments, that a detail interface of the virtual reward resource matching the target user account is displayed includes: displaying a virtual treasure box at a last growth node in each stage, where the virtual treasure box includes a plurality of to-be-obtained virtual reward resources, and a part of virtual reward resources that are in the plurality of to-be-obtained virtual reward resources and that are not obtained are about to be transferred to a virtual treasure box in next stage.

It is to be understood that, in this embodiment, there are only a specified quantity of growth levels and reward resources in each resource growth stage, and only a growth level and a reward resource in a next resource growth stage are sequentially activated each time when a resource growth stage is passed. In other words, if the user account does not take an activated reward resource in a previous resource growth stage in time, an opportunity to take the reward resource in the previous stage is lost. To resolve a technical problem that a reward resource cannot be taken in time, in this embodiment, a virtual treasure box is also displayed at a last growth node in each resource growth stage on the growth track to store reward resource information in the stage, and when entering a next resource growth stage, a reward resource in the virtual treasure box is to be simultaneously transferred to a virtual treasure box corresponding to the next stage to ensure that a reward resource that has been activated by the user can be taken in a subsequent stage.

In some embodiments, more growth nodes and virtual reward resources corresponding to the growth nodes may be provided in the foregoing virtual treasure box. It may be understood that, because reward resources on the growth track are limited in each stage, some growth nodes are all activated in advance and corresponding reward resources are taken. To satisfy requirements of these user accounts to obtain more reward resources, the virtual treasure box may be provided at a last node in each resource growth stage, and the user account may select to continue to exchange more reward resources in the virtual treasure box according to an obtained growth coefficient (for example, an empirical value obtained according to a confrontation game).

As shown in FIG. 5, in FIG. 5, a “cyclic treasure box” node is displayed at the end of a last stage on the growth track 401. In some embodiments, reward resources to be obtained are stored in the “cyclic treasure box” node. It may be understood that, in an actual interface, to display a virtual treasure box node more vividly, a virtual treasure box (not shown in the figure) may be displayed at a last growth node in each stage to prompt the user account to take a to-be-taken reward resource in the virtual treasure box.

In the foregoing embodiment of this application, a virtual treasure box is displayed at a last growth node in each stage. In this way, a manner for obtaining a virtual reward resource is more intuitively displayed, to resolve a technical problem of great difficulty in operation in the manner for obtaining the virtual reward resource in the related technology.

In some embodiments, that the growth track of the virtual reward resource is displayed in the detail interface includes: marking a location of an account identifier of a reference user account having a binding relationship with the target user account on the growth track.

It is to be understood that, in this embodiment, the foregoing growth level is determined according to a growth coefficient. In some embodiments, the foregoing growth coefficient may be represented as a game empirical value, and the game empirical value is related to game representation of the user account, may also be related to a quantity of times of gaming of the user account, and the like. The growth level determined based on the foregoing growth coefficient may be displayed on the growth track.

In this embodiment, not only a current growth level node of the user account, but also a growth level of another user account that is associated with the user account, may be displayed on the growth track. As a visual representation manner, as shown in FIG. 4, two account identifiers are displayed on the growth track 401. The account identifier 403 displayed in bold black is a location at which a growth level of the current user account is displayed on the growth track, indicating that the growth level of the current user account is level 3, but a growth coefficient of the current user account has exceeded a growth coefficient required for level 3, and there is still a specified distance from a coefficient value required for level 4. In addition, an account identifier 405, namely, an account identifier of a friend account of the current user account, is also displayed on the growth track 401, indicating that a growth level of the account is level 4, and a growth coefficient is between a growth coefficient required for level 4 and a coefficient required for level 5. In this way, in the visual manner in this embodiment, the current user account can intuitively learn the growth coefficient of the current user account and a gap between the growth level of the current user account and a growth level of an associated account such as a friend account.

In the foregoing embodiment of this application, a location of an account identifier of a reference user account having a binding relationship with the target user account is marked on the growth track. In this way, a relationship between growth levels and growth coefficients that are of the current target account and a target account associated with the current target account is more intuitively displayed, and enthusiasm of the user account to participate in a ranking system is improved.

In some embodiments, on the basis of the foregoing method, the following steps are further included:
S1: Obtain an operation presentation parameter corresponding to an operation performed by a virtual character controlled by the target user account in a target game task.
S2: Collect statistics on the operation presentation parameter, and obtain a growth coefficient.
S3: Update the current resource growth level of the target user account based on the growth coefficient.

It is to be understood that, an existing accumulated point ranking manner for a confrontation game only considers a victory or defeat case of the user account in the confrontation game. For example, a point is added only when the user account wins, and a point is deducted when the user account fails. That is to say, an existing point accumulation manner is related to only a game operation level of a user. In the manner, for a user without a good game operation level, an accumulated point rank cannot be improved quickly, resulting in being inconducive to improving enthusiasm of this part of users to participate in the game.

In this embodiment, the growth coefficient of the user account is determined through the game investigating the operation presentation parameter corresponding to the operation performed by the virtual character controlled by the target user account in the target game task. Specifically, the foregoing operation presentation parameter may include but is not limited to various parameters such as a friendliness parameter indicating friendliness of a user account, an agreement parameter indicating whether the user account complies with an agreement by performing a game operation based on a branch agreed at the start, and an operation parameter indicating operation presentation of the user account in a game. A specific type of the foregoing operation presentation parameter is not limited in this application.

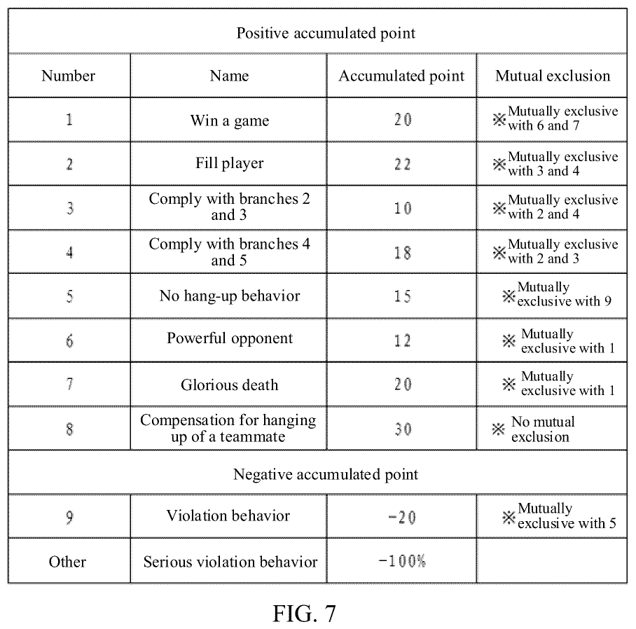

As a specific point accumulation manner, FIG. 7 shows a specific method for calculating the operation presentation parameter. As shown in FIG. 7, some operating behaviors have a mutually exclusive relationship (that is, if one behavior occurs, another behavior will not occur), then scores for the behaviors that have a mutually exclusive relationship as shown in the figure are not repeatedly calculated. In addition, in this embodiment, if the user account has violations (for example, making vulgar remarks in the game), the operation presentation parameter is deducted, and if there are serious violations (for example, using a game plug-in for game cheating), the user account of the game is not deemed to accumulate any operation presentation parameter.

After an operation presentation parameter of each game of the user account is determined through a rule shown in FIG. 7, a sum of operation presentation parameters of a plurality times of games of the user is further counted to determine a growth coefficient. When the growth coefficient of the user is determined, a current resource growth level of the user is further determined according to a correspondence between the growth coefficient and a resource growth level. For example, when a growth coefficient of 1000 points corresponds to a resource growth level of level 3, and a coefficient of 1500 points corresponds to a resource growth level of level 4, when a growth coefficient of a user account is 1200 points, a resource growth level of the user account is determined to be level 3.

In the foregoing embodiment of this application, an operation presentation parameter corresponding to an operation performed by a virtual character controlled by the target user account in a target game task is obtained; statistics on the operation presentation parameter is collected, and a growth coefficient is obtained; and the current resource growth level of the target user account is updated based on the growth coefficient. In this way, a manner for obtaining a virtual reward resource is more intuitively displayed, to resolve a technical problem of great difficulty in operation in the manner for obtaining the virtual reward resource in the related technology.

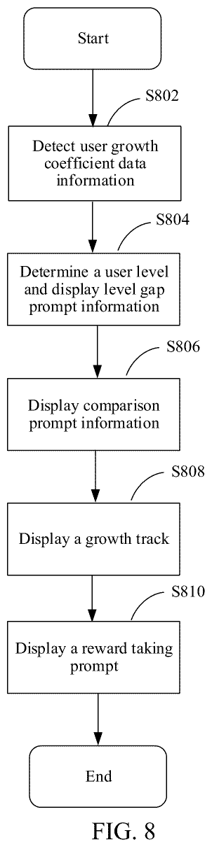

A process of the method for displaying a virtual reward resource provided in this application is described in detail with reference to procedure shown in FIG. 8.

After any user enters a battle mode selection interface of a game application, the following steps are included.
S802: Detect user growth coefficient data information.

Specifically, a growth coefficient value that a current user account has obtained and a growth coefficient value obtained in a virtual treasure box are detected.
S804: Determine a user level and display level gap prompt information.

Specifically, a growth level of the current user is determined according to the growth coefficient value of the user, a gap with a growth coefficient value of a next level is determined according to the growth coefficient value required for the next level, gap information is converted, according to the growth coefficient value, into a remaining quantity of games that need to be played, and prompt information “N games left to upgrade!” is displayed.
S806: Display comparison prompt information.

Specifically, growth level data of a friend relationship chain of the user is pulled to be compared with that of the user, and two players closest to a player are displayed to prompt the user of ID information of a friend whose growth level has been surpassed and a friend whose growth level is to be surpassed.
S808: Display a growth track.

A dan promotion status of the user is pulled, and if the user has promotion information above a specified level, a time point when a dan of the player was promoted is marked on a corresponding growth track. In addition, an icon of a reward resource corresponding to each growth level node is displayed on the growth track.
S810: Display a reward taking prompt.

A reward resource that is not currently taken by the user is pulled, and a reward resource taking prompt is displayed.

In this embodiment of this application, a progress prompt window of a virtual reward resource matching a target user account is displayed in a battle mode selection interface of a game application; a trigger operation performed on the progress prompt window is received; and a detail interface of the virtual reward resource matching the target user account is displayed, a growth track of the virtual reward resource being displayed in the detail interface, the growth track including growth nodes respectively corresponding to different resource growth levels, the growth node being for prompting a virtual reward resource and a resource obtaining status that correspond to the resource growth level, and an account identifier of the target user account being marked at a location corresponding to a current resource growth level on the growth track. In this way, by using a reward method of a virtual reward resource indicated based on the growth track, a manner for obtaining a virtual reward resource is more intuitively displayed, to resolve a technical problem of great difficulty in operation in the manner for obtaining the virtual reward resource in the related technology.

For ease of description, the foregoing method embodiments are described as a series of action combinations. However, a person skilled in the art should know that this application is not limited to the described order of the actions because some steps may be performed in another order or performed at the same time according to this application. In addition, a person skilled in the art is also to learn that the embodiments described in this specification are all exemplary embodiments, and the involved actions and modules are not necessarily required to this application.

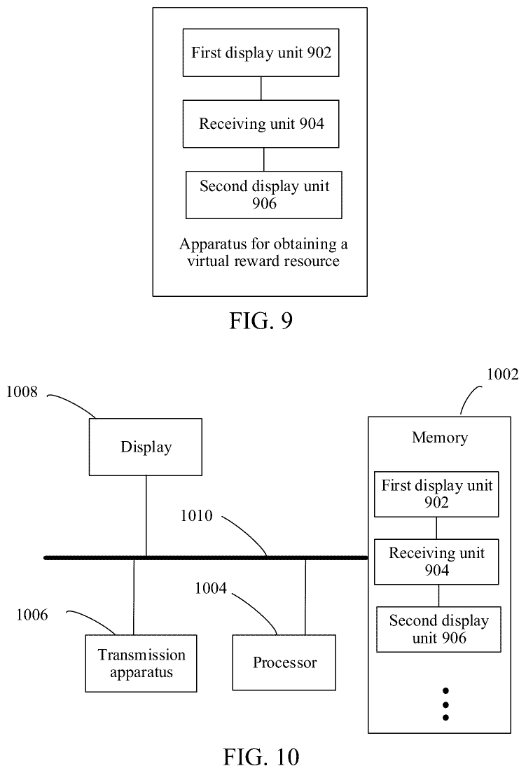

According to another aspect of the embodiments of this application, an apparatus that is for obtaining a virtual reward resource and that is configured to implement the foregoing method for obtaining a virtual reward resource is further provided. As shown in FIG. 9, the apparatus includes:
a first display unit 902, configured to display a progress prompt window of a virtual reward resource matching a target user account in a battle mode selection interface of a game application, the progress prompt window including a current resource growth level and a resource obtaining status that are of the target user account;
a receiving unit 904, configured to receive a trigger operation performed on the progress prompt window; and
a second display unit 906, configured to display, in response to the trigger operation on the progress prompt window, a detail interface of the virtual reward resource matching the target user account, a growth track of the virtual reward resource being displayed in the detail interface, the growth track including growth nodes respectively corresponding to different resource growth levels, the growth node being for prompting a virtual reward resource and a resource obtaining status that correspond to the resource growth level, and an account identifier of the target user account being marked at a location corresponding to the current resource growth level on the growth track.

In some embodiments, the first display unit 902 is configured to display a level identifier of the current resource growth level corresponding to the target user account in a current battle period in the progress prompt window; and display information about a countdown of the target user account to a resource growth stage next to a current resource growth stage in the progress prompt window.

In some embodiments, the first display unit 902 is configured to display resource obtaining prompt information in the progress prompt window, where the resource obtaining prompt information is for prompting a resource identifier of a current to-be-obtained target virtual reward resource of the target user account, the target virtual reward resource includes: a virtual reward resource of a dan reward type, a virtual reward resource of a key prop type, and a virtual reward resource of a basic prop type, a prompt priority of the virtual reward resource of the dan reward type is higher than a prompt priority of the virtual reward resource of the key prop type, and the prompt priority of the virtual reward resource of the key prop type is higher than a prompt priority of the virtual reward resource of the basic prop type.

In some embodiments, when displaying the resource obtaining prompt information in the progress prompt window, the first display unit 902 prompts, when a quantity of target virtual reward resources is greater than 1, a resource quantity of target virtual reward resources that are not taken in the progress prompt window; and/or displays the resource obtaining prompt information in the progress prompt window according to a prompt priority of the target virtual reward resource.

In some embodiments, the first display unit 902 displays comparison prompt information in the progress prompt window when the current resource growth level of the target user account is higher than a resource growth level of an associated user account, where the comparison prompt information is for prompting that the target user account has surpassed the associated user account.

In some embodiments, the second display unit 906 displays the growth track of the virtual reward resource in the detail interface, where a corresponding resource prompt icon is displayed at each growth node of the growth track, a resource prompt icon corresponding to a growth node at which a virtual reward resource has been obtained is a resource identifier of the obtained virtual reward resource, and a resource prompt icon corresponding to a growth node at which a virtual reward resource has not been obtained is a locked identifier; and displays a quantity of exchanged resources currently held by the target user account in the detail interface, where the exchanged resource is a reward resource obtained based on the growth track.

In some embodiments, the second display unit 906 is configured to adjust a first growth node sequence in the currently displayed growth track to a second growth node sequence corresponding to a sliding progress of a slide operation in response to the slide operation on the growth track; and restore the second growth node sequence in the currently displayed growth track to a third growth node sequence in response to a click/tap operation performed on a return control in the detail interface, where the third growth node sequence includes a growth node corresponding to the current resource growth level.

In some embodiments, the second display unit 906 is configured to display, in response to an operation performed on a stage prompt control in the detail interface, resource attribute information of virtual reward resources respectively included in different resource growth stages on the growth track, where resource obtaining start time corresponding to the different resource growth stages is different.

In some embodiments, the second display unit 906 is configured to display a virtual treasure box at a last growth node in each resource growth stage, where the virtual treasure box includes a plurality of to-be-obtained virtual reward resources, and a part of virtual reward resources that are in the plurality of to-be-obtained virtual reward resources and that are not obtained are about to be transferred to a virtual treasure box in next resource growth stage.

In some embodiments, the second display unit 906 marks a location of an account identifier of a reference user account having a binding relationship with the target user account on the growth track.

In some embodiments, for an embodiment to be implemented by each unit module, reference may be made to the foregoing method embodiments, and details are not described herein again.

According to another aspect of the embodiments of this application, an electronic device for implementing the foregoing method for obtaining a virtual reward resource is further provided. The electronic device may be specifically the terminal device or the server shown in FIG. 10. In this embodiment, description is made by using an example in which the electronic device is the terminal device. As shown in FIG. 10, the electronic device includes a memory 1002 and a processor 1004. The memory 1002 stores a computer program. The processor 1004 is configured to perform the steps in any one of the foregoing method embodiments through the computer program.

In some embodiments, the electronic device may be located in at least one of a plurality of network devices in a computer network.

In some embodiments, the processor may be configured to perform the following steps through the computer program:
S1: Display a progress prompt window of a virtual reward resource matching a target user account in a battle mode selection interface of a game application, the progress prompt window including a current resource growth level and a resource obtaining status that are of the target user account.
S2: Receive a trigger operation performed on the progress prompt window.
S3: Display, in response to the trigger operation on the progress prompt window, a detail interface of the virtual reward resource matching the target user account, a growth track of the virtual reward resource being displayed in the detail interface, the growth track including growth nodes respectively corresponding to different resource growth levels, the growth node being for prompting a virtual reward resource and a resource obtaining status that correspond to the resource growth level, and an account identifier of the target user account being marked at a location corresponding to the current resource growth level on the growth track.

In some embodiments, a person of ordinary skill in the art may understand that, the structure shown in FIG. 10 is only illustrative. The electronic device may be a terminal device such as a smartphone (for example, an Android phone, or an iOS phone), a tablet computer, a palmtop computer, a mobile Internet device (MID), or a PAD. FIG. 10 does not limit the structure of the electronic device. For example, the electronic device may further include more or fewer components (such as a network interface) than those shown in FIG. 10, or have a configuration different from that shown in FIG. 10.

The memory 1002 may be configured to store a software program and a module, for example, a program instruction/module corresponding to the method and apparatus for obtaining a virtual reward resource in the embodiments of this application, and the processor 1004 performs various functional applications and data processing by running the software program and the module stored in the memory 1002, that is, implementing the foregoing method for obtaining a virtual reward resource. The memory 1002 may include a high-speed RAM, and may further include a non-volatile memory such as one or more magnetic storage apparatuses, a flash memory, or another non-volatile solid-state memory. In some embodiments, the memory 1002 may further include memories remotely disposed relative to the processor 1004, and these remote memories may be connected to the terminal through a network. The foregoing examples of the network include, but are not limited to, the Internet, an intranet, a local area network, a mobile communication network, and a combination thereof. The memory 1002 may be specifically configured to, but is not limited to, store information such as each element in a scenario picture and virtual reward resource obtaining information. In an example, as shown in FIG. 10, the memory 1002 may include, but is not limited to, a first display unit 902, a receiving unit 904, and a second display unit 906 in the apparatus for obtaining a virtual reward resource. In addition, the memory may further include, but is not limited to, other module units in the apparatus for obtaining a virtual reward resource. The other module units are not described in detail in this example.

In some embodiments, a transmission apparatus 1006 is configured to receive or transmit data through a network. Specific examples of the network include a wired network and a wireless network. In an example, the transmission apparatus 1006 includes a network interface controller (NIC). The NIC may be connected to another network device and a router by using a network cable to communicate with the Internet or a local area network. In an example, the transmission apparatus 1006 is a radio frequency (RF) module, and is configured to communicate with the Internet in a wireless manner.

In addition, the electronic device further includes a display 1008, configured to display a virtual game scenario in an interface; and a connection bus 1010, configured to connect various module components in the electronic device.

In other embodiments, the terminal device or the server may be a node in a distributed system, where the distributed system may be a blockchain system, and the blockchain system may be a distributed system formed by connecting a plurality of nodes in through network communication. A peer to peer (P2P) network may be formed between the nodes. A computing device in any form, for example, an electronic device such as a server or a terminal, may become a node in the blockchain system by joining the P2P network.

According to an aspect of this application, a computer program product is provided, the computer program product includes a computer program/instructions, and the computer program/instructions includes program code for performing the method shown in the flowchart. In such an embodiment, the computer program may be downloaded and installed from a network through a communication part, and/or installed from a removable medium. When the computer program is executed by a central processing unit, various functions in the embodiments of this application are executed.

The sequence numbers of the foregoing embodiments of this application are merely for description purpose, and do not indicate the preference among the embodiments.

According to an aspect of this application, a computer-readable storage medium is provided, a processor of a computer device reads computer instructions in the computer-readable storage medium, and the processor executes the computer instructions to cause the computer device to perform the foregoing method for obtaining a virtual reward resource.

In some embodiments, the computer-readable storage medium may be configured to store a computer program for performing the following steps:
S1: Display a progress prompt window of a virtual reward resource matching a target user account in a battle mode selection interface of a game application, the progress prompt window including a current resource growth level and a resource obtaining status that are of the target user account;
S2: Receive a trigger operation performed on the progress prompt window.
S3: Display, in response to the trigger operation on the progress prompt window, a detail interface of the virtual reward resource matching the target user account, a growth track of the virtual reward resource being displayed in the detail interface, the growth track including growth nodes respectively corresponding to different resource growth levels, the growth node being for prompting a virtual reward resource and a resource obtaining status that correspond to the resource growth level, and an account identifier of the target user account being marked at a location corresponding to the current resource growth level on the growth track.

In some embodiments, a person of ordinary skill in the art may understand that all or some of the steps of the methods in the foregoing embodiments may be implemented by a program instructing relevant hardware of the terminal device. The program may be stored in a computer-readable storage medium. The storage medium may include a flash disk, a read-only memory (ROM), a random access memory (RAM), a magnetic disk, an optical disc, or the like.

When the integrated unit in the foregoing embodiments is implemented in the form of a software function unit and sold or used as an independent product, the integrated unit may be stored in the foregoing computer-readable storage medium. Based on such an understanding, the technical solutions of this application essentially, or the part contributing to the related technology, or all or some of the technical solutions may be represented in a form of a software product. The computer software product is stored in a storage medium and includes several instructions for instructing one or more computer devices (which may be a personal computer, a server, or a network device) to perform all or some of the steps of the methods in the embodiments of this application.

In the foregoing embodiments of this application, the descriptions of the embodiments have respective focuses. For a part that is not described in detail in an embodiment, reference may be made to related descriptions in other embodiments.

In the several embodiments provided in this application, it is to be understood that the disclosed client may be implemented in other manners. The described apparatus embodiment is merely exemplary. For example, the unit division is merely logical function division and may be other division in actual implementation. For example, multiple units or components may be combined or integrated into another system, or some features may be ignored or not performed. In addition, the displayed or discussed mutual couplings or direct couplings or communication connections may be implemented through some interfaces. The indirect couplings or communication connections between the units or modules may be implemented in electronic or another form.

The units described as separate parts may or may not be physically separate, and parts displayed as units may or may not be physical units, may be located in one position, or may be distributed on a plurality of network units. Some or all of the units may be selected according to an actual requirement to achieve the objectives of the solutions in the embodiments.

In addition, functional units in the embodiments of this application may be integrated into one processing unit, or each of the units may exist alone physically, or two or more units are integrated into one unit. The integrated unit may be implemented in the form of hardware, or may be implemented in the form of a software function unit.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. The foregoing descriptions are exemplary implementations of this application. A person of ordinary skill in the art may make some improvements and modifications without departing from the principle of this application and the improvements and modifications shall fall within the protection scope of this application.

What is claimed is:

1. A method for obtaining a virtual reward resource performed by an electronic device, the method comprising:
displaying a progress prompt window of a virtual reward resource matching a target user account in a battle mode selection interface of a game application, the progress prompt window comprising a current resource growth level and a resource obtaining status of the target user account;
receiving a trigger operation performed on the progress prompt window;
in response to the trigger operation on the progress prompt window, displaying a growth track of the virtual reward resource matching the target user account, the growth track comprising growth nodes respectively corresponding to different resource growth levels, each growth node prompting a virtual reward resource and a resource obtaining status that correspond to the resource growth level; and
marking an account identifier of the target user account at a location corresponding to the current resource growth level on the growth track.

2. The method according to claim 1, wherein the displaying a progress prompt window of a virtual reward resource matching a target user account comprises:
displaying a level identifier of the current resource growth level corresponding to the target user account in a current battle period in the progress prompt window; and
displaying information about a countdown of the target user account to a resource growth stage next to a current resource growth stage in the progress prompt window.

3. The method according to claim 1, wherein the displaying a progress prompt window of a virtual reward resource matching a target user account comprises:
displaying resource obtaining prompt information in the progress prompt window, wherein the resource obtaining prompt information is for prompting a resource identifier of a current to-be-obtained target virtual reward resource of the target user account.

4. The method according to claim 3, wherein the displaying resource obtaining prompt information in the progress prompt window comprises:
when a quantity of target virtual reward resources is greater than 1, prompting a resource quantity of target virtual reward resources that are not taken in the progress prompt window, and/or
displaying the resource obtaining prompt information in the progress prompt window according to a prompt priority of the target virtual reward resource.

5. The method according to claim 1, wherein the displaying a progress prompt window of a virtual reward resource matching a target user account comprises:
displaying comparison prompt information in the progress prompt window when the current resource growth level of the target user account is higher than a resource growth level of an associated user account, wherein the comparison prompt information is for prompting that the target user account has surpassed the associated user account.

6. The method according to claim 1, wherein the displaying a growth track of the virtual reward resource matching the target user account comprises:
displaying a corresponding resource prompt icon at each growth node of the growth track, wherein a resource prompt icon corresponding to a growth node at which a virtual reward resource has been obtained is a resource identifier of the obtained virtual reward resource, and a resource prompt icon corresponding to a growth node at which a virtual reward resource has not been obtained is a locked identifier; and
displaying a quantity of exchanged resources currently held by the target user account, wherein the exchanged resource is a reward resource obtained based on the growth track.

7. The method according to claim 1, wherein the displaying a growth track of the virtual reward resource matching the target user account comprises:
adjusting a first growth node sequence in the currently displayed growth track to a second growth node sequence corresponding to a sliding progress of a slide operation in response to the slide operation on the growth track; and
restoring the second growth node sequence in the currently displayed growth track to a third growth node sequence in response to a click/tap operation, wherein the third growth node sequence comprises a growth node corresponding to the current resource growth level.

8. The method according to claim 1, wherein the displaying a growth track of the virtual reward resource matching the target user account comprises:
marking a location of an account identifier of a reference user account having a binding relationship with the target user account on the growth track.

9. The method according to claim 1, further comprising:
obtaining an operation presentation parameter corresponding to an operation performed by a virtual character controlled by the target user account in a target game task;
obtaining a growth coefficient based on statistics on the operation presentation parameter; and
updating the current resource growth level of the target user account based on the growth coefficient.

10. An electronic device, comprising a memory and a processor, the memory storing a computer program that, when executed by the processor, causes the electronic device to perform a method for obtaining a virtual reward resource including:
displaying a progress prompt window of a virtual reward resource matching a target user account in a battle mode selection interface of a game application, the progress prompt window comprising a current resource growth level and a resource obtaining status of the target user account;
receiving a trigger operation performed on the progress prompt window;
in response to the trigger operation on the progress prompt window, displaying a growth track of the virtual reward resource matching the target user account, the growth track comprising growth nodes respectively corresponding to different resource growth levels, each growth node prompting a virtual reward resource and a resource obtaining status that correspond to the resource growth level; and
marking an account identifier of the target user account at a location corresponding to the current resource growth level on the growth track.

11. The electronic device according to claim 10, wherein the displaying a progress prompt window of a virtual reward resource matching a target user account comprises:
displaying a level identifier of the current resource growth level corresponding to the target user account in a current battle period in the progress prompt window; and
displaying information about a countdown of the target user account to a resource growth stage next to a current resource growth stage in the progress prompt window.

12. The electronic device according to claim 10, wherein the displaying a progress prompt window of a virtual reward resource matching a target user account comprises:
displaying resource obtaining prompt information in the progress prompt window, wherein the resource obtaining prompt information is for prompting a resource identifier of a current to-be-obtained target virtual reward resource of the target user account.

13. The electronic device according to claim 12, wherein the displaying resource obtaining prompt information in the progress prompt window comprises:
when a quantity of target virtual reward resources is greater than 1, prompting a resource quantity of target virtual reward resources that are not taken in the progress prompt window, and/or
displaying the resource obtaining prompt information in the progress prompt window according to a prompt priority of the target virtual reward resource.

14. The electronic device according to claim 10, wherein the displaying a progress prompt window of a virtual reward resource matching a target user account comprises:
displaying comparison prompt information in the progress prompt window when the current resource growth level of the target user account is higher than a resource growth level of an associated user account, wherein the comparison prompt information is for prompting that the target user account has surpassed the associated user account.

15. The electronic device according to claim 10, wherein the displaying a growth track of the virtual reward resource matching the target user account comprises:
displaying a corresponding resource prompt icon at each growth node of the growth track, wherein a resource prompt icon corresponding to a growth node at which a virtual reward resource has been obtained is a resource identifier of the obtained virtual reward resource, and a resource prompt icon corresponding to a growth node at which a virtual reward resource has not been obtained is a locked identifier; and
displaying a quantity of exchanged resources currently held by the target user account, wherein the exchanged resource is a reward resource obtained based on the growth track.

16. The electronic device according to claim 10, wherein the displaying a growth track of the virtual reward resource matching the target user account comprises:
adjusting a first growth node sequence in the currently displayed growth track to a second growth node sequence corresponding to a sliding progress of a slide operation in response to the slide operation on the growth track; and
restoring the second growth node sequence in the currently displayed growth track to a third growth node sequence in response to a click/tap operation, wherein the third growth node sequence comprises a growth node corresponding to the current resource growth level.

17. The electronic device according to claim 10, wherein the displaying a growth track of the virtual reward resource matching the target user account comprises:
marking a location of an account identifier of a reference user account having a binding relationship with the target user account on the growth track.

18. The electronic device according to claim 10, wherein the method further comprises:
obtaining an operation presentation parameter corresponding to an operation performed by a virtual character controlled by the target user account in a target game task;
obtaining a growth coefficient based on statistics on the operation presentation parameter; and
updating the current resource growth level of the target user account based on the growth coefficient.

19. A non-transitory computer-readable storage medium, comprising a stored program, the program, when executed by a processor of an electronic device, causes the electronic device to perform a method for obtaining a virtual reward resource including:
displaying a progress prompt window of a virtual reward resource matching a target user account in a battle mode selection interface of a game application, the progress prompt window comprising a current resource growth level and a resource obtaining status of the target user account;
receiving a trigger operation performed on the progress prompt window;
in response to the trigger operation on the progress prompt window, displaying a growth track of the virtual reward resource matching the target user account, the growth track comprising growth nodes respectively corresponding to different resource growth levels, each growth node prompting a virtual reward resource and a resource obtaining status that correspond to the resource growth level; and
marking an account identifier of the target user account at a location corresponding to the current resource growth level on the growth track.

20. The non-transitory computer-readable storage medium according to claim 19, wherein the displaying a progress prompt window of a virtual reward resource matching a target user account comprises:
displaying a level identifier of the current resource growth level corresponding to the target user account in a current battle period in the progress prompt window; and
displaying information about a countdown of the target user account to a resource growth stage next to a current resource growth stage in the progress prompt window.
